(19) United States
(12) Patent Application Publication
(10) Pub. No.: US 2010/0098846 A1
(43) Pub. Date: Apr. 22, 2010

(54) PATTERNED SOFT ADHESIVES AND METHOD OF MANUFACTURE

(75) Inventors: Jian Ling Ding, Glastonbury, CT (US); Rengan Kannabiran, Wayland, MA (US); Kathryn Moon, Manchester, CT (US); Robert Braiewa, Simsbury, CT (US); Brian Thomas, Bloomfield, CT (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: SCAPA NORTH AMERICA, Windsor, CT (US)

(21) Appl. No.: 12/568,202

(22) Filed: Sep. 28, 2009

Related U.S. Application Data
(60) Provisional application No. 61/101,134, filed on Sep. 29, 2008.

(51) Int. Cl. B05D 5/10; B05C 1/08

(52) U.S. Cl. 427/207.1; 118/258

(57) ABSTRACT

A method is disclosed for making a soft adhesive tape. The method comprises providing a soft adhesive, rolling a gravure cylinder on the soft adhesive to meter the soft adhesive, depositing the metered soft adhesive from the gravure cylinder onto a carrier web, and transferring the soft adhesive to a backing substrate. In exemplary implementations, the method includes drying or curing the metered soft adhesive on the carrier web before transferring the soft adhesive to the backing substrate. A system is disclosed for making a layer of soft adhesive. The system comprises an applicator containing a soft adhesive, a gravure cylinder to meter the soft adhesive from the applicator, and a carrier web passing through the gravure cylinder, the carrier web supporting the metered soft adhesive deposited by the gravure cylinder. In exemplary implementations, a dryer may be included for curing the metered soft adhesive on the carrier web.

### RELATED APPLICATION

This application claims the benefit of and priority to U.S. Provisional Application Ser. No. 61/101,134 filed Sep. 29, 2008, the contents of which are incorporated by reference herein in its entirety.

### FIELD

This disclosure relates to systems and methods for manufacturing patterned soft adhesives for application on various backing substrates to form adhesive tapes.

### BACKGROUND

Soft adhesives or gels are used in various applications. Usually, these adhesives or gels are coated on a backing substrate that provides the necessary support and structure for end use application. Often, these adhesives and gels are coated in a predetermined discontinuous pattern to facilitate permeability, drainage, gel layer strength, and adhesion level etc.

There are known patents that describe methods of creating discontinuous patterns of adhesives and gels on various backing substrates. U.S. Pat. No. 5,635,201 describes a method of applying adhesive gel to a perforated backing and blowing air to create holes (discontinuity) in the adhesive gel. U.S. Pat. No. 7,411,109 describes a method of applying the adhesive and punching holes to provide the discontinuity.

There is a need for a simple process of efficiently providing soft adhesives and gels in a discontinuous pattern on various backing substrates or a release liner.

### SUMMARY

In accordance with one aspect of the present disclosure, a method is disclosed for making a layer of soft adhesive. The method comprises providing a soft adhesive, rolling a gravure cylinder on the soft adhesive to meter the soft adhesive, and depositing the metered soft adhesive from the gravure cylinder onto a carrier web. In exemplary implementations, the method also includes drying or curing the metered soft adhesive on the carrier web.

A method is also disclosed for making a soft adhesive tape. The method comprises providing a soft adhesive, rolling a gravure cylinder on the soft adhesive to meter the soft adhesive, depositing the metered soft adhesive from the gravure cylinder onto a carrier web, and transferring the soft adhesive to a backing substrate. In exemplary implementations, the method includes drying or curing the metered soft adhesive on the carrier web before transferring the soft adhesive to the backing substrate.

In accordance with another aspect of the present disclosure, a system is disclosed for making a layer of soft adhesive. The system comprises an applicator containing a soft adhesive, a gravure cylinder to meter the soft adhesive from the applicator, and a carrier web passing through the gravure cylinder, the carrier web supporting the metered soft adhesive deposited by the gravure cylinder. In exemplary implementations, a dryer may be included for drying or curing the metered soft adhesive on the carrier web.

A system is also disclosed for making a soft adhesive tape. The system comprises an applicator containing a soft adhesive, a gravure cylinder to meter the soft adhesive from the applicator, a carrier web passing through the gravure cylinder, the carrier web supporting the metered soft adhesive deposited by the gravure cylinder, and a backing substrate contacting the soft adhesive to form a soft adhesive tape. In exemplary implementations, a dryer may be included for drying or curing the metered soft adhesive on the carrier web before the backing substrate contacts the dried or cured soft adhesive.

In one exemplary implementation, the gravure cylinder used is engraved with a predetermined pattern to deposit a discontinuous patterned soft adhesive on the carrier web.

### DRAWINGS

The above-mentioned features and objects of the present disclosure will become more apparent with reference to the following description taken in conjunction with the accompanying drawings wherein like reference numerals denote like elements and in which:

FIG. 1 is a graph comparing soft/gentle adhesives with typical pressure sensitive adhesives.

FIG. 2 is a schematic diagram illustrating an exemplary method of making an adhesive laminate material.

### DETAILED DESCRIPTION

There is a method for making a layer of soft adhesive. The method comprises providing a soft adhesive, rolling a gravure cylinder on the soft adhesive to meter the soft adhesive, and depositing the metered soft adhesive from the gravure cylinder onto a carrier web. In exemplary implementations, the method also includes drying or curing the metered soft adhesive on the carrier web.

Soft/gentle adhesives and gels are defined as having an elastic modulus of 1000 to 50,000 Pa. In one exemplary implementation, the soft/gentle adhesive or gel has a modulus of 2000 to 10,000 Pa. Soft adhesives and gels have lower elasticity values than hard adhesives and gels. In some instances, soft adhesive and gels may also have lower molecular weights. The soft adhesive or gel to be used may be decided by various factors, including the desired softness, ease of removal, target adhesion surface, and conditions of extended use.

Soft/gentle adhesives and gels include, but are not limited to, polyurethane, silicone type, acrylic type, hydrogel type, hydrocolloid type, rubber type (including styrenic block copolymer, polyisobutylene, synthetic/natural polyisoprene), plastisol type, and polyvinyl acetate type adhesives and gels. The soft/gentle adhesives may be solvent-borne, water-borne, or 100% solids, and may be pressure sensitive, solvent activated, heat activated, or water activated. In one exemplary implementation, the soft adhesive is a heavily plasticized rubber-based pressure sensitive adhesive. The soft adhesive or gel may also include additives such a fillers, preserving agents, pigments, resins, tackifiers, plasticizers, or mixtures thereof depending on the desired characteristics.

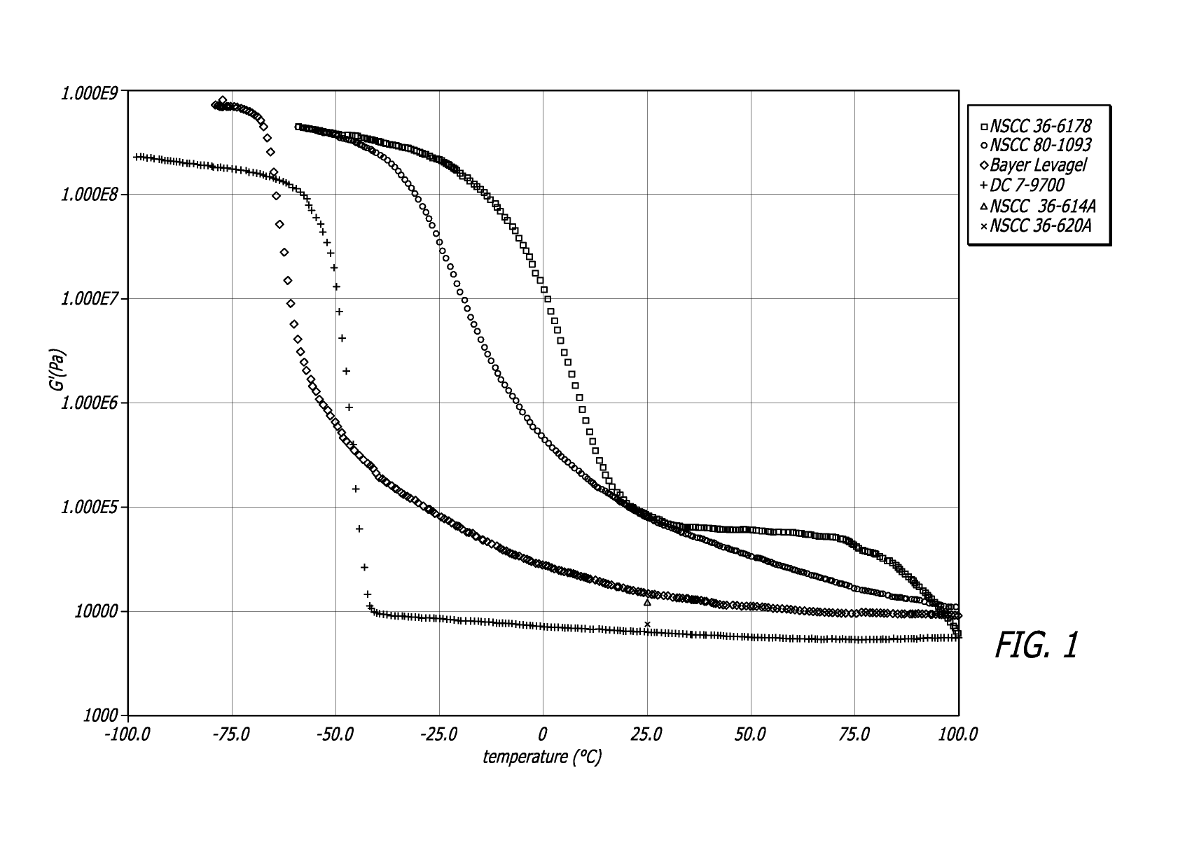

FIG. 1 is a rheology graph comparing various exemplary gentle adhesives with typical pressure sensitive adhesives (PSA). G′ is the elastic modulus, which quantifies the soft/firmness of the adhesives. Lower G′ indicates a softer adhesive, while a higher G′ indicates a firmer adhesive. The exemplary gentle adhesives, National Starch & Chemical Co. (NSCC) 36-614A, NSCC 36-620A, Bayer Levagel, and Dow Corning 7-9700 have G′ values of 5,800 Pa to 17,000 Pa over a 20° C. to 40° C. range. In some exemplary implementations, gentle adhesives may have G′ value as low as 1000 Pa. Typical pressure sensitive adhesives such as NSCC 80-1093 (general purpose acrylic) and NSCC 36-6178 (typical rubber-based PSA) have G′ values of greater than 50,000 Pa over a 20° C. to 40° C. range.

Rotogravure, or gravure, is used to meter the soft adhesive or gel. The soft adhesive or gel is applied on a gravure roller or cylinder by rolling the gravure cylinder in a reservoir containing the adhesive. The adhesive or gel may also be dispensed directly onto the gravure cylinder. A squeegee or blade may be used to scrape excess adhesive. The moving web is sandwiched between the gravure cylinder and an impression roller where the soft adhesive is transferred onto the moving web. In exemplary implementations, the gravure cylinder is engraved with a predetermined pattern depending on various conditions such as the desired adhesiveness and the specific characteristics of the selected soft adhesive or gel. The gravure cylinder may be engraved with patterns containing recesses, cavities, and indentations of uniform or varying depths and sizes. As a result of the engraved pattern, the soft adhesive or gel is deposited onto the moving web in a discontinuous, porous, or partially discontinuous/porous layout. Examples include, but are not limited to, dots and honey-comb patterns. In other exemplary implementations, instead of engraving the gravure cylinder, a gravure-type pattern is applied on a cylinder, for example, by winding a wire mesh around the cylinder.

A carrier web is used to transport the soft adhesive or gel in a predetermined layout. In exemplary implementations, the carrier web transports the soft adhesive deposited by the gravure cylinder to an oven dryer and subsequently transports the oven cured soft adhesive to be attached to a backing substrate. The carrier web may be made of any material, including but not limited to, film, rubber, plastic, cloth, and woven and non-woven fabric. The carrier web may also have various coatings, such as other adhesive materials, soft modulus coatings, and release coatings. In one exemplary implementation, the carrier web is a liner that ultimately becomes the release liner of an adhesive tape. Generally, the carrier web is provided from a spool or reel, but separate sheets of the carrier web may also be used.

A dryer is used to dry or cure the soft adhesive. Depending on the individual characteristics of the soft adhesive, drying or curing may be achieved through various processes, which include heat, UV radiation, electron beams, and chemical additives. In exemplary implementations, the dryer is an oven, using temperatures anywhere from 150-400° F.

In another aspect, there is a method for making a soft adhesive tape. The method comprises providing a soft adhesive, rolling a gravure cylinder on the soft adhesive to meter the soft adhesive, depositing the metered soft adhesive from the gravure cylinder onto a carrier web, and transferring the soft adhesive to a backing substrate. In exemplary implementations, the method includes drying or curing the metered soft adhesive on the carrier web before transferring the soft adhesive to the backing substrate.

The backing substrate may be made of any material, including but not limited to, film, rubber, plastic, cloth, and woven and non-woven fabric. In one exemplary implementation, the soft adhesive is transferred by contact lamination to a side of the backing substrate. Because the backing substrate is not required to pass through the dryer, the backing substrate may advantageously be made of heat sensitive material or be very thin. The soft adhesive or another type of adhesive may also be applied to the other side of the backing substrate. Generally, the backing substrate is provided from a spool or reel, but separate sheets of the backing substrate may also be used.

There is a system for making a layer of soft adhesive. The system comprises an applicator containing a soft adhesive, a gravure cylinder to meter the soft adhesive from the applicator, and a carrier web passing through the gravure cylinder, the carrier web supporting the metered soft adhesive deposited by the gravure cylinder. In exemplary implementations, a dryer may be included for drying or curing the metered soft adhesive on the carrier web.

In another aspect, there is a system for making a soft adhesive tape. The system comprises an applicator containing a soft adhesive, a gravure cylinder to meter the soft adhesive from the applicator, a carrier web passing through the gravure cylinder, the carrier web supporting the metered soft adhesive deposited by the gravure cylinder, and a backing substrate contacting the soft adhesive to form a soft adhesive tape. In exemplary implementations, a dryer may be included for drying or curing the metered soft adhesive on the carrier web before the backing substrate contacts the dried or cured soft adhesive.

The applicator introduces the soft adhesive or gel to the gravure cylinder. In one exemplary implementation, the applicator comprises an adhesive dispensing port and a reservoir or pan to hold the soft adhesive. The gravure cylinder is partially immersed in the reservoir. As the gravure cylinder rotates, soft adhesive is drawn out of the reservoir. A squeegee or blade is used to scrape excess adhesive back into the reservoir. The applicator may be any means for introducing the soft adhesive or gel to the gravure cylinder, such as a spray, brush, or direct outlet port.

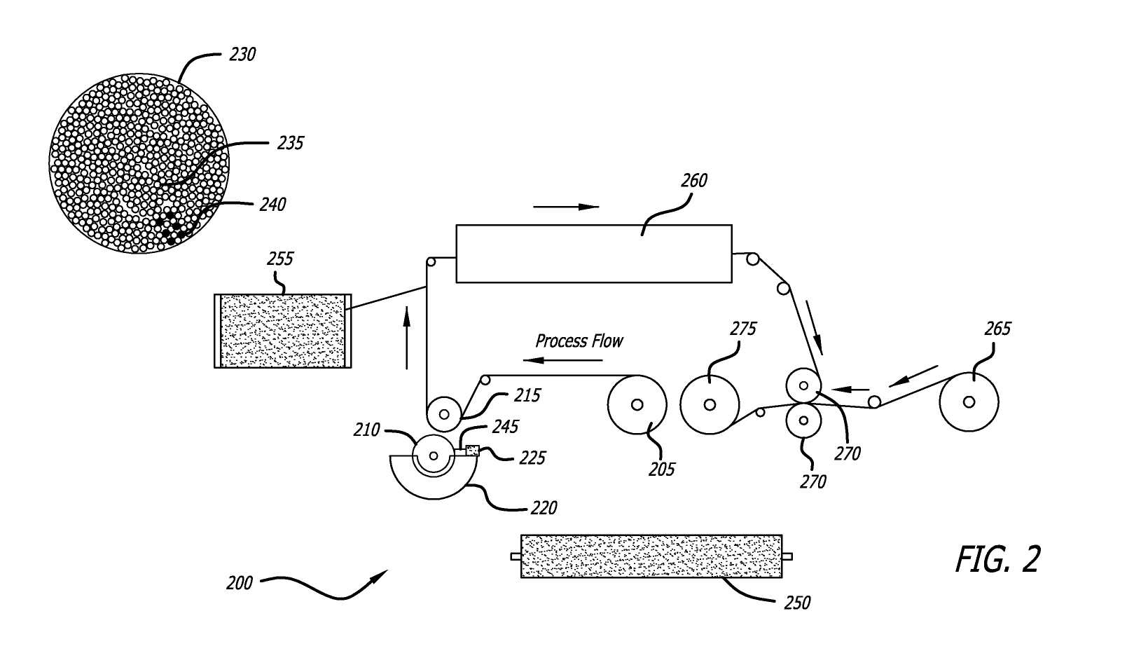

FIG. 2 shows an exemplary implementation of a system 200 for manufacturing a soft adhesive tape. A carrier web in the form of a liner is supplied on a spool 205. As the liner is unwound into an assembly line, it is sandwiched between a patterned gravure cylinder 210 and an impression roller 215. Soft adhesive is supplied in a reservoir 220 for imprinting onto one surface of the liner. The soft adhesive in the reservoir 220 is supplied by a dispensing port 225. A gravure cylinder 210 partially rests in the reservoir 220, and by rotary movement thereof, its surface receives a coating of the soft adhesive. The rotating gravure cylinder 210 is positioned so as to make contact with the soft adhesive as well as the surface of liner during its rotation.

The surface of the gravure cylinder 210 is etched or engraved to form a preselected pattern of spaced, generally circular recesses 235, each having a predetermined diameter and depth. Item 230 depicts the magnified surface of the gravure cylinder 210, and item 250 shows a side view of the gravure cylinder. As the gravure cylinder 210 rotates in the reservoir 220, the recesses 235 are filled with soft adhesive 240. A doctor blade 245 removes the excess soft adhesive from the surface of the gravure cylinder 210, but not from the recesses 235. Continued rotation of the gravure cylinder 210 brings the soft adhesive filled recesses 240 into contact with the surface of the liner, where the soft adhesive is imprinted as raised adhesive microdots. Item 255 depicts the surface of the liner having imprinted raised adhesive microdots.

Sandwiching the liner with an impression roller 215 on the other side, the gravure cylinder 210 exerts a preselected pressure against the liner during the printing process in order to achieve a selected depth of imprint of the microdots into the liner. In this manner, the depth of the recesses 235 and imprinting pressure cooperatively determine the depth of the imprinted microdots on the surface of the imprinted liner. The size, depth, distribution, and arrangement of the recesses 235 on the gravure cylinder 210 may be preselected to imprint microdots in any desirable pattern.

The imprinted liner passes through an oven 260 for evaporation of any solvent residue and curing of the soft adhesive solution to a tacky gel. The liner is then joined under pressure with a backing substrate. The backing substrate is supplied from a spool 265 and, together with the liner, sandwiched between impression rollers 270. The finished product, a soft adhesive tape, is wound onto rolls 275 of manageable size. During usage, the liner may be removed to expose a soft adhesive tape having an adhesive layer imprinted on a backing substrate with spacing between the adhesive dots depending on desired adhesive characteristics.

It is to be understood that while certain forms of the present disclosure have been illustrated and described herein, it is not to be limited to the specific forms or arrangement of parts described and shown.

Multiple gravure cylinders 210 and ovens 260 may be used in succession to coat multiple layers or coat a single pattern containing different adhesives on a carrier web. A carrier web may be removed and directly reused again in the assembly process after the adhesive has been transferred to the backing substrate.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method for making a layer of soft adhesive, the method comprising:
providing a soft adhesive;
rolling a gravure cylinder on the soft adhesive to meter the soft adhesive; and
depositing the metered soft adhesive from the gravure cylinder onto a carrier web.

2. The method of claim 1 further comprising at least one of the steps of drying the metered soft adhesive on the carrier web and curing the metered soft adhesive on the carrier web.

3. The method of claim 2 wherein the curing step is accomplished by at least one of a heat, UV radiation, electron beam, and chemical additive process.

4. The method of claim 1 wherein the soft adhesive is one of a polyurethane, silicone type, acrylic type, hydrogel type, hydrocolloid type, rubber type, styrenic block copolymer, polyisobutylene, synthetic polyisoprene, natural polyisoprene, plastisol type, and polyvinyl acetate type gel.

5. The method of claim 1 wherein the gravure cylinder is engraved with a predetermined pattern.

6. A method for making a soft adhesive tape, the method comprising:
providing a soft adhesive;
rolling a gravure cylinder on the soft adhesive to meter the soft adhesive;
depositing the metered soft adhesive from the gravure cylinder onto a carrier web;
transferring the soft adhesive to a backing substrate.

7. The method of claim 6 further comprising at least one of the steps of drying the metered soft adhesive on the carrier web and curing the metered soft adhesive on the carrier web before transferring the soft adhesive to a backing substrate.

8. The method of claim 7 wherein the curing step is accomplished by at least one of a heat, UV radiation, electron beam, and chemical additive process.

9. The method of claim 6 wherein the soft adhesive is one of a polyurethane, silicone type, acrylic type, hydrogel type, hydrocolloid type, rubber type, styrenic block copolymer, polyisobutylene, synthetic polyisoprene, natural polyisoprene, plastisol type, and polyvinyl acetate type gel.

10. The method of claim 6 wherein the gravure cylinder is engraved with a predetermined pattern.

11. A system for making a layer of soft adhesive, the system comprising:
an applicator containing a soft adhesive;
a gravure cylinder to meter the soft adhesive from the applicator; and
a carrier web passing through the gravure cylinder, the carrier web supporting the metered soft adhesive deposited by the gravure cylinder.

12. The system of claim 11 further comprising a dryer for drying or curing the metered soft adhesive on the carrier web.

13. The system of claim 11 wherein the soft adhesive is one of a polyurethane, silicone type, acrylic type, hydrogel type, hydrocolloid type, rubber type, styrenic block copolymer, polyisobutylene, synthetic polyisoprene, natural polyisoprene, plastisol type, and polyvinyl acetate type gel.

14. The system of claim 11 wherein the gravure cylinder is engraved with a predetermined pattern.

15. A system for making a soft adhesive tape, the system comprising:
an applicator containing a soft adhesive;
a gravure cylinder to meter the soft adhesive from the applicator;
a carrier web passing through the gravure cylinder, the carrier web supporting the metered soft adhesive deposited by the gravure cylinder; and
a backing substrate contacting the soft adhesive to form a soft adhesive tape.

16. The system of claim 15 further comprising a dryer for drying or curing the metered soft adhesive on the carrier web before the backing substrate contacts the soft adhesive.

17. The system of claim 15 wherein the soft adhesive is one of a polyurethane, silicone type, acrylic type, hydrogel type, hydrocolloid type, rubber type, styrenic block copolymer, polyisobutylene, synthetic polyisoprene, natural polyisoprene, plastisol type, and polyvinyl acetate type gel.
